(19) United States
(12) Patent Application Publication
(10) Pub. No.: US 2019/0308161 A1
(43) Pub. Date: Oct. 10, 2019

(54) System and Method for Enhanced Chemical Reaction, Dissociation, and Separation by Electrostatic/Microwave and/or Radio Frequency Controlled Resonant Electron Interaction

(71) Applicant: United States Department of Energy, Washington, DC (US)

(72) Inventors: Wayne A. Surdoval, Monroeville, PA (US); David A. Berry, Mt. Morris, PA (US)

(21) Appl. No.: 16/375,448

(22) Filed: Apr. 4, 2019

Related U.S. Application Data
(60) Provisional application No. 62/652,860, filed on Apr. 4, 2018.

(51) Int. Cl. B01J 19/08; B01J 19/12; C01B 3/02; C05C 3/00; C05C 9/00

(52) U.S. Cl. CPC B01J 19/088; B01J 19/126; B01J 19/129; C01B 3/025; C05C 3/00; B01J 2219/0875; B01J 2219/0809; B01J 2219/0815; B01J 2219/1242; B01J 2219/1239; C05C 9/00

(57) ABSTRACT

A system and method for increase chemical reaction rates and/or lower reaction temperatures. The system relates to a chemical reactor including non-electrically conducting support and an electron source in communication with the support. The reactor further includes an electromagnetic source in communication with at least the electron source and the non-electrically conducting support.

### CROSS-REFERENCE TO RELATED APPLICATIONS

This application claims the benefit of U.S. Provisional Application No. 62/652,860 filed on Apr. 4, 2018, the disclosure of which is incorporated herein by reference.

### GOVERNMENT INTEREST

The United States Government has rights in this invention pursuant to the employer-employee relationship of the Government to the inventors as U.S. Department of Energy employees and site-support contractors at the National Energy Technology Laboratory.

### FIELD OF THE INVENTION

The disclosure provides a system and method for increasing chemical reaction rates and/or lowering reaction temperatures. Embodiments also relate to increased dissociation rates and separation of a specific dissociated component using an ionically conductive membrane. More specifically embodiments relate to applying a specific energy source to a specific electron emission material allow for increasing in chemical reaction rates and/or lower reaction temperatures of gas phase chemistry.

### BACKGROUND

The disclosure provides a system and method for increasing chemical reaction rates and/or lowering reaction temperatures. Embodiments relate to increased dissociation rates and separation of a specific dissociated component using an ionically conductive membrane. More specifically embodiments relate to applying a specific energy source to a specific electron emission material allowing for increased chemical reaction rates and/or lower reaction temperatures of gas phase chemistry.

Systems and methods disclosed herein enable reducing the cost of a large number of important industrial processes including; nitrogen and hydrogen production and the like. Approximately fifty percent of natural gas is used in such industrial processes by industry, with a substantial percentage used for fertilizer production. The existing ammonia process, the Haber process, is a very energy intensive, and costly process. The Haber process reaction conditions has a significant economic impact on the increasing use of fertilizer.

There is an urgent need to reduce energy and cost in known industrial processes. Thus there is a need to increase chemical reaction rates and/or lowering reaction temperatures. In certain applications there is further a need to increase dissociation rates and separation of a specific dissociated component using an ionically conductive membrane.

The following article is incorporated herein by reference in its entity: R A FRANZ, A RAYMOND and F APPLEGATH. “A New Urea Synthesis. I. The Reaction of Ammonia, Carbon Monoxide, and Sulfur.” The Journal of Organic Chemistry 26.9 (1961): 3304-3305.

These and other objects, aspects, and advantages of the present disclosure will become better understood with reference to the accompanying description and claims.

### SUMMARY

One or more embodiments relate to a chemical reactor. The chemical reactor includes an electrode-support assembly and an electromagnetic source in communication with at least the electrode support assembly.

One or more embodiment relates to a chemical reactor including non-electrically conducting support and an electron source in communication with the support. The reactor further includes an electromagnetic source in communication with at least the electron source and the non-electrically conducting support.

Yet another embodiment relates to a chemical reactor. The chemical reactor includes a non-electrically conducting support; and at least one cathode non-electrically conducting support assembly. The reactor includes at least one anode non-electrically conducting support assembly spaced from the cathode non-electrically conducting support assembly and an external circuit coupled to at least one cathode and at least one anode permitting electrons to flow between them. The chemical reactor further includes an electromagnetic source selected from the group consisting of a microwave source or an rf source, the electromagnetic source in communication with at least the cathode non-electrically conducting support assembly.

Still another embodiment relates to a method for performing at least one of increasing reaction rates of a chemical mixture and the dissociation/separation of a chemical mixture. The method includes providing a gas phase of the chemical mixture to an electrode-support assembly; providing electromagnetic energy to the electrode support assembly; and producing a product from the electrode-support assembly.

Still other embodiments include the electrode-support assembly comprises a non-electrically conducting support. The electrode-support assembly includes at least one cathode and at least one anode coupled to an external circuit permitting electrons to flow between them, completing a circuit. The cathode and anode are spaced, one from another enabling gas flow there between.

Further, the chemical reactor the electromagnetic source is either a microwave source or an rf source. The electromagnetic source is positioned to interact with a cathode electrode-support assembly and an anode electrode-support assembly opposing the cathode and electromagnetic source, allowing for gas flow there between.

Embodiments may include the electrode non-electrically conducting support assembly is solid and designed to contain a gas between the at least one cathode and the at least one anode. The non-electrically conducting support may be an ionically conducting support isolated from a gas channel between at least one cathode and the at least one anode from the gas channel on opposing sides of the non-electrically conducting support that collects a separated gas component.

Various embodiments of the methodology disclosed are further demonstrated and described in the following description.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts an illustration of a microwave enhanced rector in accordance with one embodiment;

FIG. 2 depicts an illustration of microwave enhanced reactor providing dissociation and separation in accordance with one embodiment;

FIG. 3 depicts an illustration of a small experimental microwave electrode assembly; and

FIG. 4 depicts an end view of the support plates of the small experimental microwave electrode assembly.

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically

One or more embodiments relates to the application of a specific energy source (radio frequency RF and/or microwave MW) to a specific electron emission material, allowing for an increase in chemical reaction rate and/or lower reaction temperature of gas phase chemistry.

More specifically, embodiments may include at least one or more of the following:
Electron source materials provide a strong source of electrons to the gas phase of a chemical mixture where the source of electric potential is applied to a circuit between the cathode and anode. The materials are chosen to be both minimally conductive and to possess low energy electron surface states. In at least one embodiment, examples of such electron source materials are either perovskite or double perovskite.
A microwave source that is 10 Ghz or lower which extends into the radio frequencies.
The microwave/radio frequency source interacts with the dielectric constant of the electrode/support material which in turn interacts with the electron energy state/electric potential in order to produce the desired electron emission energy compatible with the attachment shape resonance of the reactant molecule of interest. The combination of microwave/radio frequency source and electron energy state/electric potential controls the emitted electron energy.
In one embodiment an ionically conducting support material coupled with the electrode material enables separation of a gas phase molecule following attachment.

One or more embodiments relates to the coupling of a specific energy source (radio frequency RF and/or microwave MW) to a specific electron emission material, allowing for an increase in chemical reaction rate or lower reaction temperature of gas phase chemistry.

At least one or more embodiments includes a high-density source of electrons that activates the oxygen or nitrogen in a gas mixture. The activation forms a negative ion based on an attachment resonance at a specific attachment resonance energy which is specific and therefore selective for the molecule of interest in the chemical reaction. This form of low energy attachment is a resonance phenomenon highly specific to the molecule of interest. The electrode materials typically function over a 200° C. to 800° C. temperature range and must have sufficient conductivity to transport electrons at the rate consistent with the chemical reaction but sufficiently low conductivity to minimize the skin depth of the electrode/support structure. The lower the temperature and the higher the electron attachment rate at the required electron energy the lower the thermal energy requirements of the reactor system. Thermal energy of a reaction is replaced by the electrostatic inertial energy of the attached molecule. The microwave/radio frequency enhanced dielectric function permits release of electrons at lower field strengths also resulting in lower energy requirements and control of low-energy electron emission energy consistent with individual molecular attachment resonance. The creation of superoxide and peroxide or anionic carbon dioxide or nitrogen at low energy electron resonances along with acceleration of resonantly attached ions from the cathode region to anode will reduce thermal energy requirements for chemical reaction. The use of conductive oxides as electrodes at temperatures as low as 200° C. will reduce energy requirements. The lower operating temperature and other enhanced reaction efficiencies will be permitted by the increased kinetics, removal of reactant ions and in certain reactions, more favorable thermodynamics.

In principle many different reactions may be activated using the same physics.

One or more embodiments relate to a chemical reactor contained between cathode(s) and anode(s). This arrangement will both emit electrons at the cathode(s) at a controllable electron energy and provide a driving potential between the cathode(s) and anode(s). The electrons will attach to neutral atomic specie, constituents of the molecular specie comprising the reactants, at a specific resonant energy which is different for and characteristic of the different atoms comprising the molecules. The negative attached atoms may be driven to the anode through the neutral reactants with additional energy. In addition the negative atoms will exhibit an attractive Van Der Waal's force for the typically neutral atoms of the desired reactant and a repulsion from the negatively charged attached molecules of the same molecular specie enhancing mixing and proximity of reactants. The attachment of electrons to individual atoms which are constituents of larger neutral molecules is a low energy resonance phenomena. The specific negatively charged specie will have three effects in the reaction mixture as described below, This process requires much less energy than processes such as arc plasmas including Dielectric Barrier Discharge. This may reduce the energy requirements of the reaction system which can in turn reduce process and reactor cost.

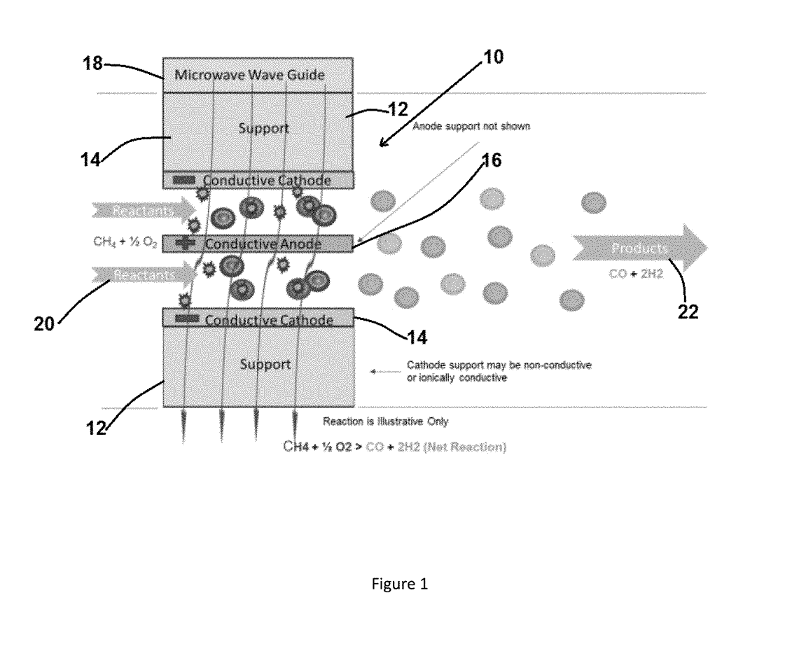

FIG. 1 depicts one embodiment of reactor 10 adapted to provide microwave/rf enhanced reaction. In the embodiment illustrated in FIG. 1, reactor 10 includes a non-electrically conductive support 12, where the support 12 may be non-ionically conductive (<109 S/m at 25° C. for example) or ionically conductive. As illustrated, the reactor 12 includes an electrode source/cathode 14 in communication with the support 12 and an electron receptor/anode 16, where electrode source/cathode 14 and electron receptor/anode 16 electrically communicating with an external circuit (not shown) that provides an electric potential. In at least one embodiment, the electron receptor/anode 16 communicates with an anode support (not shown).

FIG. 1 further illustrates the electrode source/cathode 14 and electron receptor/anode 16 are spaced one from the other, permitting gas flow between them and permitting electrons to flow between them completing the circuit. Rector 12 further includes an electromagnetic source 18 in communication with support 12 and the electrode source/cathode 14 in communication with the support 12, where the electromagnetic source 18 interacts with the cathode 14 and anode 16. In one or more embodiments, the electromagnetic source 18 comprises at least one radio frequency RF source and/or a microwave MW source.

FIG. 1 illustrates that the reactor 12 enables reactants 20 to pass or flow between the cathode 14 and anode 16, whereby electrons can flow through the reactants 20, thereby forming products 22. In one exemplary embodiment, the reactants 22, including CH₄ and 1/2O₂, and the products 22 include CO and 2H₂.

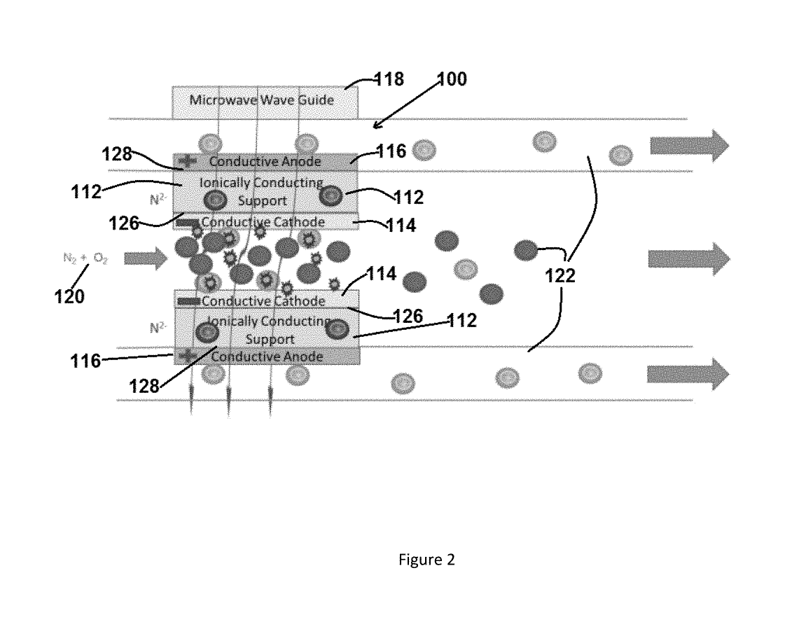

FIG. 2 depicts one embodiment of reactor 100 adapted to provide microwave/rf enhanced dissociation and separation. In the element illustrated in FIG. 2, reactor 100 includes an ionically conductive support 112 As illustrated, the reactor 100 includes one or more electrode source/cathodes 114 in communication with the one surface 126 of the support 112 and one or more electron receptor/anodes 116 in communication with another surface 128 of the support 112., where electrode source/cathodes 114 and electron receptor/anodes 116 electrically communicating with an external circuit (not shown) that provides an electric potential. In the illustrated embodiment, surface 128 opposes surface 126, although other relationships are contemplated.

FIG. 2 further illustrates the two or more electrode source/cathodes 114 are spaced one from the other, permitting gas flow between them. Rector 112 further includes an electromagnetic source 118 spaced from at least one electrode receptor/anode 114, permitting gas flow there between. In the illustrated embodiment, the electromagnetic source 118 interacts with the anode 116. In one or more embodiments, the electromagnetic source 118 comprises at least one radio frequency RE source and/or a microwave MW source. FIG. 2 illustrates that the reactor 112 enables reactants 120 to pass or flow between the cathodes 114, and between the electromagnetic source 118 and at least one anode 116, whereby electrons can flow through the reactants 120, thereby forming products 122. In one exemplary embodiment, the reactants 122, including N₂ and O₂, where N²⁻is attracted to the anodes and can be dissociated at the surface vacancies and transported and separated via a porous electrode and ionically conductive support 116 thereby separating N₂ from O₂.

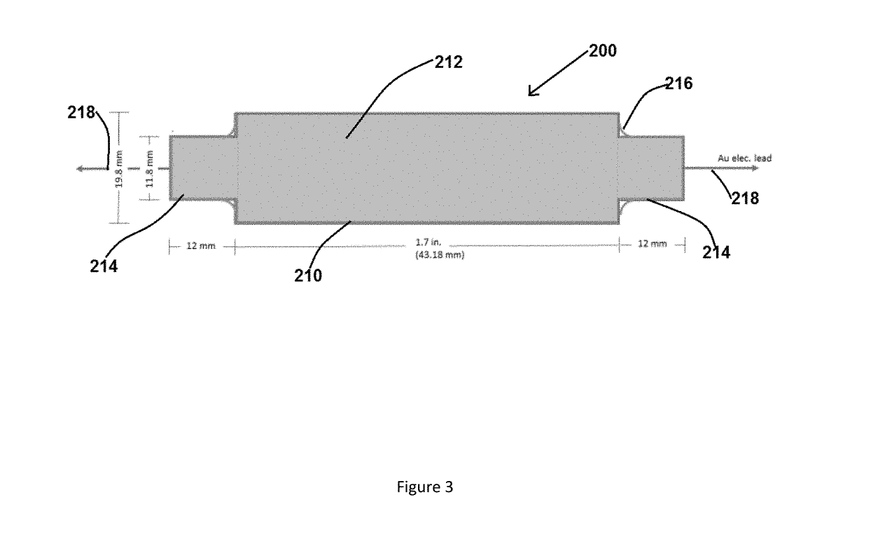

FIG. 3 depicts one embodiment of a small experimental microwave electrode assembly, generally designated 200. The assembly 200 includes support 210 and electrode 212. In the illustrated embodiment, the support 212 is a lanthanum strontium titanate (LaSrTiO2) 3-4 mm while the electrode 212 is a LSM 50 micros or less. Assembly 200 includes protrusions 214 extending from opposing ends, each protrusion 214 having electrical lead 218. In the illustrated embodiment, electrical leads 218 are Gold Au embedded in an electrode. In FIG. 3 the assembly 200 is about 68 mm in length, where each protrusion 214 is about 12 mm in length. The assembly 200 is about 19.8 mm wide, where the protrusion 214 is about 11.8 mm wide. Further any corners are radiused to minimize stress points. support plates of the small experimental microwave electrode assembly

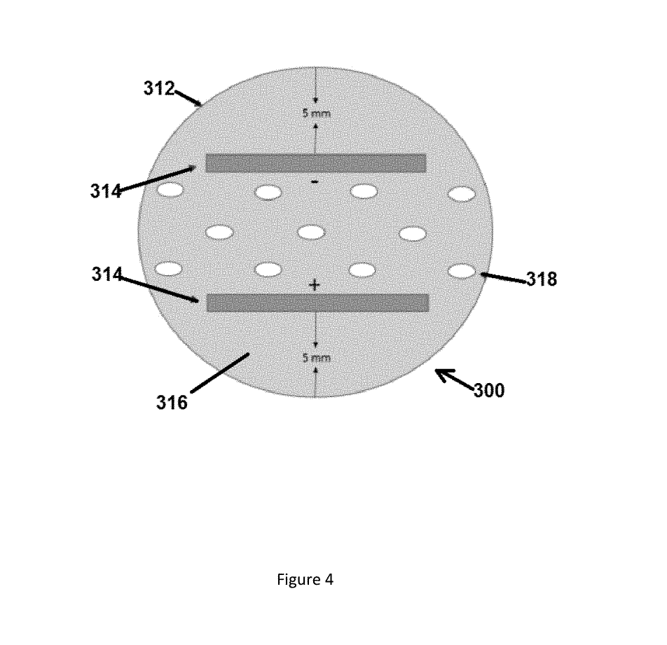

FIG. 4 illustrates an end view of an end support plate 300 of the small experimental microwave electrode assembly of FIG. 3. In the illustrated embodiment, the support plate is a circle having a diameter of 19.8 mm, but any shape and dimension is contemplated. FIG. 4 depicts two electrode plate slots 316 spaced from each other and about 5 mm from circumference 312. As illustrated, the electrode plate slots 316 are about 11.8 mm×3 mm and match the electrode assembly tab thickness as necessary. The end support plate 300 includes one or more gas passage holes having a diameter of about 2 mm and permit gas flow. The electrode support 300 should be free to move and not rigid and should be the same material as the support 10/100 for thermal expansion. In one embodiment, the reactor tube is 20 mm diameter quartz oriented vertically. The microwave guide is perpendicular and is 1.7 in high.

Electrons can be produced by electron emission under a potential with or without use of a microwave or other radio frequency device but requires the microwave/radio frequency to control the emitted electron energy.

Attachment of electrons to reactants is a resonance phenomenon that will have a significant cross-section at a specific electron energy corresponding to the resonance of a specific reactant. At non-resonance energies attachments effectively does not occur.

The electron energy largely corresponds to the electron emission energy and driving potential between the cathode and anode and the interaction of non-attachment collisions. This combination results in the drift velocity. In most cases it is the energy of the drift velocity that must agree with the resonant energy for attachment of electrons to a specific reactant.

The attachment of the electron does not represent a permanent ionized state and is essentially an extra electron added to a neutral molecule as a shape resonance with sufficient transient lifetime to enable a driving force to accelerate reactants from the cathode through the reactant mixture toward the anode enhancing proximity of charged reactant(s) to uncharged reactant(s) and increasing the kinetic energy of the charged reactants known to enhance reaction rates and dependent on the driving potential between the anode and cathode. The attached ions will also promote mixing due to repulsion between the specific ions based on the unique attachment resonance of any specific reactant. It is also possible to dissociate a molecule by the attachment of an electron. This is also a resonance process and typically occurs at a higher energy than the non-dissociative attachment resonance but would also enhance the reaction rate if energetically favorable. Dissociation can also be promoted by the attachment ions interaction with the vacancies in the cathode support material or by the enhanced collisions caused by acceleration of ions between the cathode and anode. The attachment of an electron to a reactant creates a metastable state with a lifetime on the order of 1 picosecond. A collision between a molecule with an attached electron and a neutral molecule tends to stabilize the attached electron, extending the lifetime of the metastable state. Multiple collisions can take place prior to reaction.

The cathode will establish a potential between itself and an anode that is facing the cathode. The geometry and number of cathode and anode arrangements will be selected based on reactor geometry.

The electrons emitted from the cathode 12/112 reaches a drift velocity. The attached state is achieved when the energy associated with the drift velocity equals the resonance energy for attachment at which point the negatively charged atom will be subject to the driving potential. The drift energy at the resonance of attachment will be different and, depending on gas pressure greater of less than the cathode potential so that the voltage at the cathode 14/114 typically does not necessarily correspond directly to the energy of the attachment resonance. The attraction between charged and neutral specie and the repulsion of charged specie further increase the energy of interaction and result in substantial mixing with negative and neutral specie preferentially in proximity due to repulsion between charged specie.

Cathode/Anode electrodes are selected based on emission properties, strength, toughness and stability, conductivity and a balance between properties characteristic of microwave penetration minimizing reflection and adsorption (primarily conductivity) and the conductivity necessary to supply electrons for emission. For microwave or radio frequency applications, skin depth must be considered, limiting the thickness of the conductive electrodes and the use of a preferably non-electrically conductive support 12/112. Examples of materials that meet the criteria for use as an electrode are Lanthanum Strontium Manganite and Lanthanum Barium Cobaltite. The support 12/112 must be non-conductive on the order of 1E-09 S/m at 25 C. The support 12/112 may be ionically conductive. Examples of a non-ionically conducting support include Lanthanum or Barium Strontium Titanate or Aluminate and for an ionically conducting support Yttrium Stabilized Zirconia. Another combination of electrode and support would be thin film (4-12 atomic layers) Lanthanum Aluminum Oxide (electrode) and either Strontium Titanate or Lanthanum Aluminate-Strontium Aluminum Tantalate as a support for the deposited thin film. Other combinations of thick electrode/support or deposited thin film electrode support that are similar in function as the examples exist and could be used. The electrodes may be solid or porous, thin or thick based on the above stated considerations or other considerations, but must maintain adequate conductivity corresponding to the desired emission rate. The surface area should be consistent with the desired reaction rate of electron emission. The reactor 10/100 containing the electrodes and reactants must be designed to permit egress of the microwave/if and necessary wiring.

Excess electrons will exit via the anode 16/116. Attached electrons will ultimately exit via the anode 16/116 given that attachment is a metastable state and does not enter the overall reaction stoichiometry.

Molecules or mixtures of molecules that are absorbed on the surface of the electrodes may be removed by the same process, By ramping through a voltage range the resonance for electron attachment for any mixture of absorbed specie may be reached. When attachment occurs, the negative molecule will be repelled from the electrode surface into the gas environment and removed by the gas flow. The polarity of the electrodes can be reversed to clean both cathode and anode prior to use. Removal of carbon would be an example.

If employed, microwave or radio frequency interacts with the dielectric of the support 12/112 and cathode 14/114 material which in combination with cathode 14/114 voltage adjusts the emitted electron energy to correspond with the specie specific attachment resonance energy ultimately based on the drift velocity characteristics of the gas. The application of the microwave or radio frequency also reduces the potential or energy required for electron emission. It is important to note that the process described is an electron emission/attachment mechanism and not a barrier breakdown required by typical plasma generation such as electrical arcing and dielectric barrier discharge in which positive ions are created in the gas, These types of typical plasma generation require much higher electron energy requirements and therefore higher overall energy consumption.

One or more embodiments create a chemical reactor 10/110 contained between cathode(s) 14/114 and anode(s) 16/116 which may be supported by an ionically conducting material or a solid support 10/100 depending on the desired application. This arrangement enables emitting electrons at the cathode(s) 14/114 and provide a driving potential between the cathode(s) 14/114 and anode(s) 16/116. The ionically conducting material will both assist in dissociation of attached molecules and conduct one of the atomic specie to the outside of each electrode where it can be either recombined and captured as a separation process or reacted as an atomic ion with other reactants to form a desired product. One example includes attaching an electron to a nitrogen molecule for separation and use in ammonia/urea/fertilizer production. Another example includes attachment of an electron to hydrogen in methane for separation of hydrogen and use in ammonia/urea/fertilizer production. Yet another example includes the attachment of an electron to oxygen in carbon dioxide which separates the oxygen leaving carbon monoxide available in the gas phase for use in urea/fertilizer production.

Interaction of the negatively charged nitrogen molecule with an electropositive vacancy in an ion conductive support 10/100 covered by a somewhat porous cathode 14/114 is one method for dissociation. The electropositive vacancy can interact strongly with negatively attached molecule (attachment to one atom of the molecule). With the electric field at the very outer cathode atomic surface driving the single atom into the vacancy and dissociating the atom from the molecule. For example, the ionic conductor may be an oxygen ionic conductor in the case of dissociated atomic nitrogen given the virtually identical atomic radius of oxygen and nitrogen. Ionic conduction will occur to the opposite and sealed side of the electrode which can then react very actively with, for example, hydrogen to produce ammonia for use as fertilizer or other applications. The reaction may also include carbon monoxide produced from carbon dioxide in a similar manner in a separate reactor which can then be used in the presence of sulfur to produce urea at relatively mild conditions. Although the attachment cross-sections for the nitrogen molecule or carbon dioxide molecule is not nearly as large as for example the oxygen molecule, the conditions required for production of ammonia or urea would be substantially reduced from those required for the Haber process. The very low energy electrons will attach to neutral atomic specie, constituents of the molecular specie comprising the reactants, at a specific resonant energy which is different for and characteristic of the different atoms comprising the molecules.

The attachment of electrons to individual atoms which are constituents of larger neutral molecules represents a low energy resonance phenomenon. The vacancies of the ionic material are electropositive and interacts strongly with the negative attached atom. Under an appropriate driving potential across the ionically conducting support 10/100, dissociation of the atom may occur followed by conduction in a compatible ionic conductor. This reduces the energy requirements of the reaction system which can in turn reduce process and reactor cost.

Electrons may be produced by electron emission under a potential with or without use of a microwave or other radio frequency device. Attachment of electrons to reactants is a resonance phenomenon that has a significant cross-section at a specific electron energy corresponding to the resonance of a specific reactant. The width of the resonance is on the order of 0.1 volts but at non-resonance energies attachment effectively does not occur which permits attachment to the specific atom of interest.

The attachment of the electron does not represent a permanent ionized state and is essentially an extra electron added to the system, enabling a driving force to accelerate reactants from the cathode through the reactant mixture toward the anode. The attachment of an electron to a reactant creates a metastable state with a lifetime on the order of 1 picosecond. A collision between a molecule with an attached electron and a neutral molecule tends to stabilize the attached electron, extending the lifetime of the metastable state. Multiple collisions may take place prior to reaction.

The cathode 14/114 and anode 16/116 are supported by an ionic conductor 10/100. The support 10/100 may be an ionic conductor which may be used to separate chemical specie. Oxygen, nitrogen and hydrogen are three important examples of atomic specie that can be separated in this manner. The anode 16/116 electrode will be on the side of the support 10/100 opposite the cathode 14/114 face so that attached molecules will be driven to the anode 16/116 support.

The specie of interest may be selectively attached as described herein, The attached specie carry a metastable negative charge with a lifetime on the order of 1 picosecond which may be stabilized to longer lifetimes through collision with other molecules or surfaces. The negative metastable ion interacts with the more electropositive vacancy of the ionically conducting support participating in the dissociation of the parent molecule. Important examples of specie amenable for attachment are the oxygen molecules, nitrogen molecules and the oxygen atom of the water molecules. The interaction of the attached molecule with the vacancy, when combined with the driving potential across the ionic support, greatly facilitates the molecular dissociation which has been shown to be the limiting step for recovery of individual atomic specie. The atomic specie conducts through the ionic conductor as a function of the driving potential and can then recombine into pure diatomic molecules, either oxygen or nitrogen, or undergo reaction on the respective face of the support opposite the cathode 14/114. It should be appreciated that a driving potential will exist both between the cathode 14/114 and anode 16/116 and across the ionic support if such a support is utilized.

The driving force of the potential can add energy to the dissociation at the vacancy. Oxygen naturally conducts through an oxygen vacancy and the nitrogen, once dissociated, should also conduct via an oxygen vacancy given the almost identical atomic size of oxygen and nitrogen. These atomic specie are then available for recombination or reaction. Hydrogen itself could be dissociated and transported as a highly reactive atomic specie using an ionically conducting hydrogen membrane or the source of hydrogen could be produced by attaching the oxygen molecule of a water molecule followed by transport across an oxygen conducting membrane. In this case of further reaction of the dissociated and separated specie, the electrode supports are sealed from the inertial electrostatic attachment chamber to isolate the separated specie.

The geometry and number of cathode 14/114 and anode 16/116 arrangements will be selected based on reactor geometry. Cathode/Anode electrodes will be selected based on emission properties, stability and conductivity. The electrodes should in general be thin (order of microns) and should be porous to permit and enhance permeability but must maintain conductivity. The surface area should be consistent with the desired reaction rate and rate of electron emission established by the voltage/dielectric/attachment energy considerations.

The cathode support may be dense, porous or an ionic conductor. An anode can be placed on the opposite side of the cathode support which will provide a driving force for any attached molecules that interact with vacancies of the support. In the case of oxygen, two resonances at essentially 0 electron volts (eV) and 1.6 eV exist. Electrons will also be attached in the bulk gas in the inertial electrostatic attachment chamber and be driven to the opposing support and anode as previously described above. Once electrons are attached to the specific neutral molecule in the gas phase, these molecules will be accelerated gaining non-thermal energy in the process and will engage in collisions with neutral molecules that can directly result in gas phase chemical reaction. Attached negative molecules in the gas phase will not interact through repulsion so that collision and reaction can be specific to an attached negative molecule and a neutral molecule.

Excess electrons will exit via the anode(s). If employed, microwave or radio frequency interacts with the dielectric of the support 10/100 and cathode 14/114 material which reduces the potential or energy required for electron emission and provides a control over the desired electron emission energy. For microwave or radio frequency applications, skin depth (electrode and support thickness) must be considered, limiting the thickness of the electrically conductive materials accordingly. The support 10/100 is preferably not electron conductive although ionic conductivity would have to be evaluated if microwave or radio frequency dielectric enhancement is employed. Ionic conductivity may or may not reflect or adsorb depending on specific frequencies utilized.

In cases where undesired contamination of electrodes occurs, atoms, molecules or mixtures of molecules that are absorbed on the surface of the electrodes can be removed by the same process. By ramping through a voltage range, the resonance for electron attachment for any mixture of absorbed specie can be reached, When attachment occurs, the negative specie will be repelled from the electrode surface into the gas environment and removed by the gas flow. The polarity of the electrodes can be reversed to clean both cathode 14/114 and anode 16/116 prior to use.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A chemical reactor comprising;
an electrode-support assembly; and
an electromagnetic source in communication with at least the electrode support assembly.

2. The chemical reactor of claim 1 wherein the electrode-support assembly comprises a non-electrically conducting support.

3. The chemical reactor of claim 1 wherein the electrode-support assembly comprises at least one cathode and at least one anode coupled to an external circuit permitting electrons to flow between them, completing a circuit.

4. The chemical reactor of claim 3 wherein the cathode and anode are spaced, one from another enabling gas flow there between.

5. The chemical reactor of claim 1 wherein the electromagnetic source is selected from a group consisting of a microwave source and an rf source.

6. The chemical reactor of claim 3 wherein the electromagnetic source is positioned to interact with a cathode electrode-support assembly and an anode electrode-support assembly opposing the cathode and electromagnetic source, allowing for gas flow there between.

7. The chemical reactor of claim 2 wherein the non-electrically conducting support is non-conductive on the order of 1E-09 Sim at 25° C.

8. The chemical reactor of claim 2 wherein the non-electrically conducting support is selected from the group consisting of ionically and non-ionically conducting material.

9. The chemical reactor of claim 8 wherein the non-electrically conducting support is selected from the group comprising Lanthanum, Barium Strontium Titanate, Aluminate, Yttrium Stabilized Zirconia, Strontium Titanate, and Lanthanum Aluminate.

10. The chemical reactor of claim 2 further including at least one reactant provided at an electrode side of the non-electrically conducting support and at least one product received from a non-electrode side of the non-electrically conducting support.

11. The chemical reactor of claim 10 wherein the electrode non-electrically conducting support assembly is solid and designed to contain a gas between the at least one cathode and the at least one anode.

12. The chemical reactor of claim 2 wherein the non-electrically conducting support is an ionically conducting support isolated from a gas channel between at least one cathode and the at least one anode from the gas channel on opposing sides of the non-electrically conducting support that collects a separated gas component.

13. A chemical reactor comprising;
a non-electrically conducting support;
at least one cathode non-electrically conducting support assembly;
at least one anode non-electrically conducting support assembly spaced from the cathode non-electrically conducting support assembly;
an external circuit coupled to at least one cathode and at least one anode permitting electrons to flow between them; and
an electromagnetic source selected from the group consisting of a microwave source or an RF source, the electromagnetic source in communication with at least the cathode non-electrically conducting support assembly.

14. The chemical reactor of claim 13 wherein the spaced at east one cathode and at least one anode enable gas flow there between.

15. The chemical reactor of claim 13 wherein the electromagnetic source is in communication with the cathode non-electrically conductive support assembly.

16. The chemical reactor of claim 13 wherein the electromagnetic source is spaced from at least one cathode assembly and one anode assembly, allowing for gas flow there between.

17. The chemical reactor of claim 13 wherein the non-electrically conducting support is non-conductive on the order of 1E-09 S/m at 25° C.

18. The chemical reactor of claim 13 wherein the non-electrically conducting support is selected from the group consisting of ionically or non-ionically conducting material.

19. The chemical reactor of claim 13 wherein the non-electrically conducting support is selected from the group consisting of Lanthanum, Barium Strontium Titanate, Aluminate, Yttrium Stabilized Zirconia, Strontium Titanate, and Lanthanum Aluminate.

20. The chemical reactor of claim 13 further including at least one reactant provided between the cathode non-electrically conducting support assembly and anode non-electrically conducting support assembly and at least one product received at another side of the electrode non-electrically conducting support assembly.

21. The chemical reactor of claim 10 wherein the non-electrically conducting support is solid and designed to contain a gas between the at least one cathode and the at least one anode.

22. The chemical reactor of claim 13 wherein the non-electrically conducting support is an ionically conducting support with a gas channel between at least one cathode non-electrically conducting support assembly and at least one anode non-electrically conducting support assembly with the non-electrically conducting support side of the assembly separated from the gas channel that collects a separated gas component.

23. A method for performing at least one of increasing reaction rates of a chemical mixture and the dissociation/separation of a chemical mixture, the method comprising:
providing a gas phase of the chemical mixture to an electrode-support assembly; providing electromagnetic energy to the electrode support assembly; and
producing a product from the electrode-support assembly.
